(19) United States
(12) Patent Application Publication
(10) Pub. No.: US 2025/0045850 A1
(43) Pub. Date: Feb. 6, 2025

(54) A SYSTEM AND METHOD FOR ENFORCEABLE AND DIVISIBLE TOKENIZATION OF PROPERTY

(71) Applicant: UREEQA INC., Kitchener (CA)

(72) Inventors: Harsch KHANDELWAL, Kitchener (CA); Thomas K. HUNTER, Waterloo (CA)

(21) Appl. No.: 18/717,089

(22) PCT Filed: Dec. 7, 2022
(86) PCT No.: PCT/CA2022/000066

§ 371 Date: Jun. 6, 2024

Related U.S. Application Data
(60) Provisional application No. 63/286,807, filed on Dec. 7, 2021.

(51) Int. Cl. G06Q 50/18; G06Q 20/36; G06Q 20/38

(52) U.S. Cl. CPC G06Q 50/18; G06Q 20/3672; G06Q 20/389

(57) ABSTRACT

A system and method of enforceable and divisible tokenization of property. The system and method include the minting if validated and child NFTs for a piece of property (intellectual or real) which may represent ownership of the piece of property. Legal contracts, voting smart contracts and/or payment smart contracts may be included in the NFTs that define different ownership, voting or revenue agreements associated with the validated and child NFTs.

### CROSS-REFERENCE TO OTHER APPLICATIONS

The current disclosure claims priority from U.S. Provisional Application No. 63/286,807 filed Dec. 7, 2021 which is hereby incorporated by reference.

### FIELD

The disclosure is generally directed at managing property ownership and, more specifically, at a system and method for enforceable and divisible tokenization of property.

### BACKGROUND

Intellectual property (IP) is a category of property that relates to creations of the mind. Examples of intellectual property include inventions; symbols; names; sounds and other indicia; works of authorship, such as a literary, artistic, or musical works and designs based on visual features (e.g. ornamentation) applied to articles. Intellectual property may be protected via patents, trademarks, copyrights, industrial designs and the like.

With respect to copyright, an article such as a sound recording, a painting, or a graphical design may be subject to copyright protection. A key requirement for the existence of copyright is originality related to the creation of the work of authorship. Digital and other assets such as tangible works of authorship are desirable for purchase and sale. Immutable leger technology, such as a blockchain, facilitates minting tokens (e.g. non-fungible tokens (NFTs)) to represent such digital or other assets for recording transactions and tracking assets in a network.

Owners of intellectual property do not currently have easy ways to sell fractional ownership stakes. If fractional ownership stakes exist for a piece of intellectual property, they are accompanied by legal agreements, which typically are not made public. This creates a lack of transparency which leads to, in some cases, “back door” deals that are unknown to some stakeholders resulting in legal proceedings. This can also relate to real property.

Blockchain technology allows distributed, secure, immutable proof to be brought to the handling of intellectual property rights and ownership. Various decentralized ledger technologies have been proposed to track intellectual property ownership and royalty payments, however, these systems have not been successful in bridging the blockchain space and legal space to provide a verifiable, enforceable and secure means of tracking and verifying copyright ownership and transactions. In other words, just because technology can represent ownership does not mean that ownership, as recorded, will stand up in courts when the matters are settled.

Therefore, there is provided systems and methods for enforceable and divisible tokenization of property.

### SUMMARY

In one aspect of the disclosure, there is provided a method of enforceable and divisible tokenization of property including generating a validated non-fungible token (NFT) based on a validated item submission; generating at least one child NFT based on the validated NFT; and storing the validated NFT and the child NFT on the blockchain.

In another aspect, generating a validated NFT includes receiving a package of proof representing the validated item submission; receiving a legal contract associated with the validated item submission; and minting at least one validated NFT based on the package of proof and the legal contract. In a further aspect, the disclosure includes before minting the validated NFT, generating a hash of the legal contract; and minting the validated NFT based n the package of proof an the legal contract includes storing the hash in the minted validated NFT. In another aspect, the method includes receiving a request for a legal contract update; receiving approval of legal contract update; receiving legal contract update; generating a legal contract update hash; and re-minting the validated NFT with the legal contract update hash. In yet another aspect, generating at least one child NFT includes minting at least one child NFT based on the validated NFT and associating the at least one NFT with the validated NFT. In yet a further aspect, the disclosure includes assigning ownership rights for each of the at least one child NFTs. In yet another further aspect, minting at least one child NFT includes minting the at least one child NFT with a legal contract hash. In another aspect, minting at least one child NFT includes minting at least one of the at least one child NFTs with a payment smart contract outlining a payment relationship between owners of the at least one child NFT and the validated NFT. In yet another aspect, the payment smart contract is associated with a legal contract.

In another aspect, generating a validated NFT based on a validated item submission includes generating a batch of fungible tokens as a proxy for ownership shares or rights. In a further aspect, generating a validated NFT includes minting the validated NFT with a voting smart contract outlining voting rules with respect to ownership of the validated NFT and the at least one child NFT. In another aspect, the voting smart contract is associated with the legal contract. In another aspect, generating a validated NFT further includes minting the validated NFT with a payment smart contract outlining a payment relationship between owners of the validated NFT. In a further aspect, the payment smart contract is associated with the legal contract.

### DESCRIPTION OF THE DRAWINGS

Embodiments will now be described, by way of example only, with reference to the attached drawings, in which:

FIG. 1 is a schematic diagram of a system for intellectual property management;

FIG. 2a is a flowchart showing one embodiment of a method for minting a validated NFT;

FIG. 2b is a schematic diagram showing a combined system and method for minting a validated NFT;

FIG. 3a is a flowchart showing one embodiment for encoding a legal contract into an NFT;

FIG. 3b is a schematic diagram showing a combined system and method for minting a validated NFT with a legal contract;

FIG. 4 is a chart showing interactions between a validated NFT smart contract, a voting smart contract and a payment smart contract;

FIG. 5a is a flowchart showing one embodiment of a method for making a contract amendment;

FIG. 5b is a schematic diagram showing a combined system and method for making a contract amendment;

FIG. 6a is a flowchart showing one embodiment of a method for making a contract amendment with voting or payment smart contact update;

FIG. 6b is a schematic diagram showing a combined system and method for making a contract amendment with voting or payment smart contract update;

FIG. 7a is a flowchart showing one embodiment of a method for minting a child NFT;

FIG. 7b is a schematic diagram showing a combined system and method for minting a child NFT; and

FIG. 8 is another chart showing interactions between components of the system.

### DETAILED DESCRIPTION

The disclosure is described through certain embodiments thereof, which are described herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

In the following, while a method and system for enforceable and divisible tokenization of a creative work protected by copyright is disclosed in accordance with embodiments, it is understood that the method and system may be applied to other forms of intellectual property such as, but not limited to, patents, trademarks and industrial designs. The disclosure may also be used for the enforceable and divisible tokenization of non-intellectual or real property such as, but not limited to, cigars, tickets or real estate.

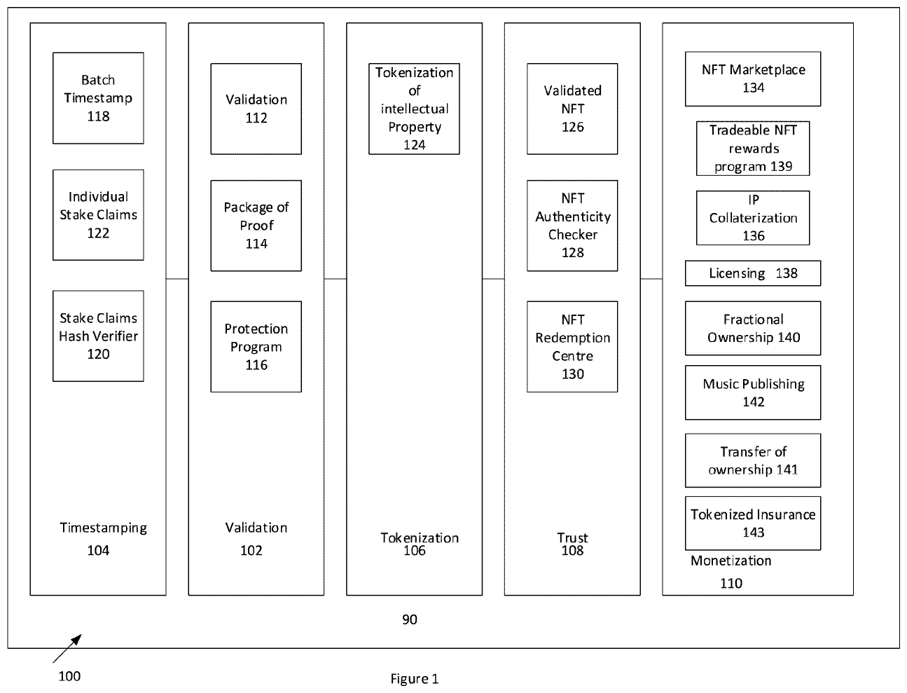

Turning to FIG. 1, a schematic diagram of a system for protecting, managing and/or monetizing creative works is shown. In one embodiment, the system 100 provides a process and functionality for creators to apply various levels of protection to their creative work, tools to verify the protection of that creative work, processes to provide ongoing monitoring of their creative work, and processes to monetize their creative work using a combination of traditional and blockchain technology. The system 100 may be stored or implemented via a server 90 (such as a web server) that may be in communication with a file server, a database and a blockchain. The system 100 includes at least one processor for executing a program or programs that implement the functionality described herein. In operation, a creator or user interacts with the system from a user computing device, such as, but not limited to, a computer or a smart device.

In the current embodiment, the system 100 includes a decentralized validation of intellectual property (IP), or validation, component 102; a decentralized timestamping of intellectual property, or timestamping, component 104; an enforceable and divisible tokenization of intellectual property, or tokenization, component 106; an encapsulating trust mechanisms into non-fungible tokens (NFTs), or trust, component 108; and a monetization component 110. The system may also be used for the decentralized validation of property.

With respect to the timestamping component 104, the timestamping component 104 enables creators to post a permanent record (with a timestamp) of their creative work to the blockchain, in a short period of time, such as in minutes. The timestamping component 104 records the claim, or submission, of the creative work as a public, immutable record on a blockchain that the creator can use to prove the creative work is theirs. In one embodiment, the decentralized timestamping of intellectual property component 104 allow claims of ownership to be made quickly and inexpensively by creating, for example, a one-way hash of a submitted creative work on a blockchain (for example, a public blockchain such as Ethereum). This may be seen as a process of decentralized timestamping of intellectual property.

Once a claim of ownership is made, the blockchain will store immutable proof to secure the timestamp of submission. In the current embodiment, the decentralized timestamping of intellectual property component 104 includes a batch timestamp component 118, a stake claim hash verifier component 120 and an individual stake claims component 122. The batch timestamp component 118 and the individual stake claims component 122 may be seen as two modules, executing on the processor that is in communication with a blockchain that may be able to perform the timestamping of intellectual property on, or to, the blockchain. In one embodiment, the decentralized timestamping of intellectual property component may enable creative works to be created as a record on the blockchain in a batch manner (via batch timestamp component 118) or individually (via individual stakes claim component 122). For the stake claim hash verifier component 120, a hashing function is used to verify the timestamps created from the batch timestamp 118 and/or individual stake claim 122 components. In a particular embodiment, only the hashed file or a zip file (which contains the creative work and other information) provided by the user will be able to generate the stored hash on the blockchain entry. This enables users to prove the claim/timestamp on the blockchain, including the date and time, the name of the user who created the timestamp, and other information. The timestamping component 104 may be seen as the first level of protection that a creator, or user, can use to protect their creative work.

With respect to validation component 102, the validation component 102 may be seen as a next level of protection after the timestamping component 104. The decentralized validation of intellectual property component 102 may include a validation determination component 112, a package of proof component 114 and a protection program component 116 (which may also be seen as a decentralized protection of intellectual property component). The validation determination component 112 may provide the functionality to allow creators of a creative work to increase protection of their creative work by validating the provenance of the creative work. Component 112 provides the functionality to validate the authorship, ownership, and originality, among other things, of an artist's creative work, such as in the form of a validation process. In one embodiment, the validation process may include interaction of the system, executing on the processor, with a team of global validators who work together in a gig-like fashion. In one embodiment, during the validation process, the decentralized network of certified validators may provide input to the system to validate the creative work based on validation criteria, such as, but not limited to, the point in time that the creative work was originated; the authorship and ownership of the creative work; and/or the uniqueness of the creative work. In one embodiment of the validation process, in a gig-like fashion, validators, that may be located globally, will be notified of an electronic creative work submission and the first certified validator(s) to accept the notification get the work. The results generated, or determined, by the validation determination component 112 may then be summarized in a Package of Proof (which may be generated by the package of proof component 114) that documents all steps taken to prove the authenticity of the creative work which may then be stored on the blockchain. The Package of Proof is a permanent, public record stored on the blockchain that the creator can use to prove the work is theirs.

The protection program component 116 may provide the functionality of decentralized protection of intellectual property. In one embodiment, the protection program component interacts with a set of protectors who search the internet and databases for unauthorized and/or unreported use of a creator's creative work and reports any such uses to the creator.

With respect to the protection program component 116, as part of component 102, the system may engage with a network of protectors, where the protectors may be located globally, to scour the digital and physical world for unauthorized and/or unreported use of protected creations. The network of protectors may then interact with the protection program component to assist the system in protecting the creative work from unauthorized use.

In one embodiment of use, the network of protectors may use internal and/or 3^{rd} party technology and databases to identify unreported and/or unauthorized use which is then input to the system via the protection program component 116. In one embodiment, this unauthorized use may be reported and action taken by the system such as, but not limited to, sending out demand letters with links to remedy via payment of a specified amount. In some cases, protectors may be engaged to perform routine monthly checks for unauthorized use. In other cases, the regular monitoring of unauthorized and/or unreported use of IP on platforms like ISPs, using component 116, can be seen as part of a due diligence process that ISPs may employ as part of their response to regulation and lawsuits dealing with copyright infringement on their platforms

With respect to the tokenization component 106, once a piece of creative work is validated through the validation component 102, the tokenization component 106 enables the tokenization of the creative work through non-fungible tokens (NFTs). In one embodiment, anyone can mint an NFT, whether they own the creative work or not. The system 100 and tokenization component 106 provides processes to mint NFTs that have been authenticated, or validated, by validation determination component 112, to generate validated NFTs. Only a creative work that has undergone validation, such as via validation determination component 112, will be minted as a validated NFT. Validated NFTs will include a reference to the Package of Proof generated by the package of proof component 114 and other important information to improve trust and transparency in NFTs. In the current embodiment, the tokenization component 106 includes an enforceable tokenization of intellectual property component 124. The tokenization component 106 leverages the strengths of blockchain technology while integrating and respecting the legal contracts required to make the ownership and transfer of NFTs enforceable. In some cases, validated NFTs will include relevant legal documents in the NFTs blockchain record, by way of hashing functions, to enable the transfer of NFTs in a manner that makes the transfer enforceable by the legal system. Tokenization of intellectual property component 124 also enables creators to mint child NFT(s) that are tied to the validated NFT. Child NFTs may also incorporate legal contracts, through hashing functions, to provide rights to the owners of the Child NFTs. In some cases, Child NFTs provide opportunities for monetization of the creative work, such as, for example, licensing, syndication, or the like.

With respect to the encapsulating trust, or trust component 108, the trust component 108 encapsulates trust with respect to the validated, or child, NFT. In one embodiment, the trust component 108 includes a validated NFT component 126, a NFT authenticity checker component 128, and a NFT redemption centre component 130. The encapsulation of trust component may provide trust and transparency to owners, buyers and sellers of NFTs. The encapsulation component 108 may provide the functionality to mint a validated NFT and to then, if desired, mint a collectible NFT associated with the validated NFT. These collectible and validated NFTs may be authenticated by the encapsulation component so that purchasers of these NFTs may have confirmation that they are purchasing an authentic NFT. The NFT authenticity check components 128 and the NFT redemption centre component 130 may be seen as tools that an owner, buyer or seller of NFTs can use to confirm the authenticity of the NFT and confirm information regarding the status of utilities associated with the NFT.

With respect to the monetization component 110, while components 104 (timestamping), 102 (validation), 106 (tokenization), and 108 (encapsulating trust) provide the user with the functionality or processes to protect and tokenize their creative work, the monetization component 110 provides a process for creators to monetize their creative work. In the current embodiment, the monetization component 110 includes a NFT marketplace component 134, an IP Collateralization component 136, a licensing component 138, a fractional ownership component 140, a tokenized tradeable rewards component 139, a transfer of ownership component 141, a tokenized intellectual property insurance component 143 and a music publishing admin (MPA) component 142. The monetization component may provide the functionality for a creator who owns validated creative work, a validated NFT and/or child NFT to monetize their creative work. These monetization processes are enabled by component 110 via its integration with components 104, 102, 106 and 108. The monetization component 110 may provide a plurality of different options for a creator to select and then guides the creator through the process to monetize the creative work in the selected manner. For example, by utilizing results generated by the validation component 102 and tokenization component 106, this may provide important information about the NFT and the associated creative work to an individual or corporation to collateralize the NFT or underwrite insurance on the NFT (using tokenized intellectual property insurance component 143). In another example, utilizing validation component 102, tokenization component 106, and trust component 108, a NFT marketplace (component 134) may provide more trust and transparency to NFT transactions. Although disclosed above with respect to intellectual property, the above system may also be used for the protection of non-intellectual or real property. Use of the term intellectual property above and in the following may also include non-intellectual or real property.

The disclosure is directed at the implementation or functionality of the enforceable and divisible tokenization of property (intellectual or real), or tokenization, component 106 of FIG. 1. In order to implement the component 106 to allow for multiple party ownership of intellectual property, the intellectual property being protected, such as, but not limited to, a creative work, is split into two different types or sets of NFTs. One of the NFT types is a validated NFT and the other of the NFT types is a Child NFT.

A validated NFT may be seen as an NFT that has been validated by the system as being authentic. In one embodiment, the creative work may be validated by the decentralized validation of intellectual property component in FIG. 1. Different methods of validation are disclosed in U.S. Provisional Application No. 63/139,092 filed Jan. 19, 2021 entitled System and Method for Protecting, Managing and Monetizing Creative Works and U.S. application Ser. No. 17/578,921 entitled System and Method for Protecting, Managing and Monetizing Creative Works Using Blockchain, both of which are hereby incorporated by reference. A Child NFT may be seen as an NFT representing a license of the original intellectual property/creative work that can also be owned by others whereby the owner of the validated NFT still maintains their ownership.

To allow for multiple ownership of a single piece of intellectual property or creative work, the disclosure utilizes a NFT standard that allows for the creation of a set or batch of fungible tokens for the original NFT that act as a proxy for shares or rights to ownership and revenue streams. One example of such a NFT standard is the ERC-1155 NFT standard. The batch of tokens are also fungible between themselves, however, they are non-fungible when compared to a batch of tokens minted for another creative work. In one embodiment, the disclosure uses the ERC-1155 NFT standard to represent the ownership of the intellectual property in the creative work, to facilitate various features to the NFT and/or to connect the NFT within the ecosystem described in this disclosure.

The disclosure refers to embodiments (e.g. systems and methods) that use Ethereum blockchain standards, however, this hybrid method of fungible tokens batched to represent a non-fungible token for creative work can be applied to other Layer 1 blockchains or Layer 2 solutions. The use of batched fungible tokens and the particular token standard for such tokens describes the technical implementation of ownership of intellectual property in the creative work, which allows for divisible, transparent IP ownership. As noted above, the decentralized nature of blockchain technology and the centralized nature of the legal system can be used in conjunction to provide improved IP protection for IP owners. In some embodiments, the disclosure may also provide legal documents to provide enforceability to in cases or jurisdictions that do not respect the validation and tokenization disclosure herein.

This generation of the NFT for the validated intellectual property results in the generation of a validated NFT. In one embodiment, assuming that the owner of the intellectual property/creative work would like to represent the ownership as 100 shares, in this example, a batch of 100 fungible tokens are minted as an ERC-1155 NFT. Assuming that the original owner (which may be the creator of the creative work) sells 75 of the 100 fungible tokens making up the validated NFT, the original owner would retain a 25% share of the intellectual property in the creative work.

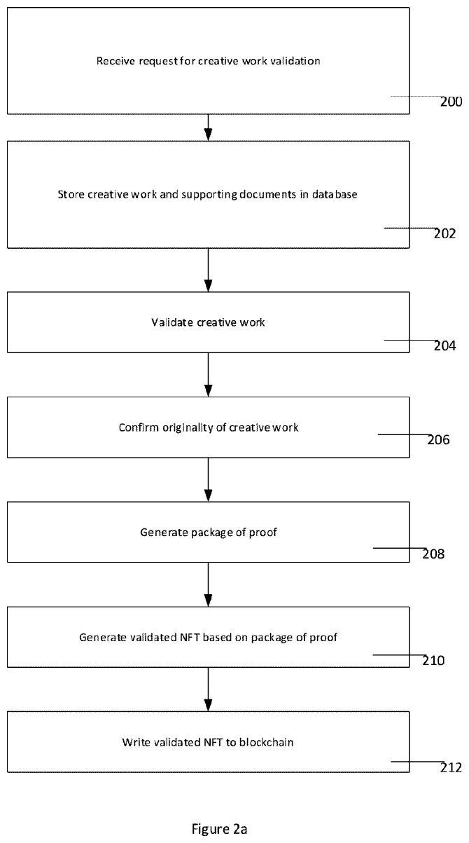

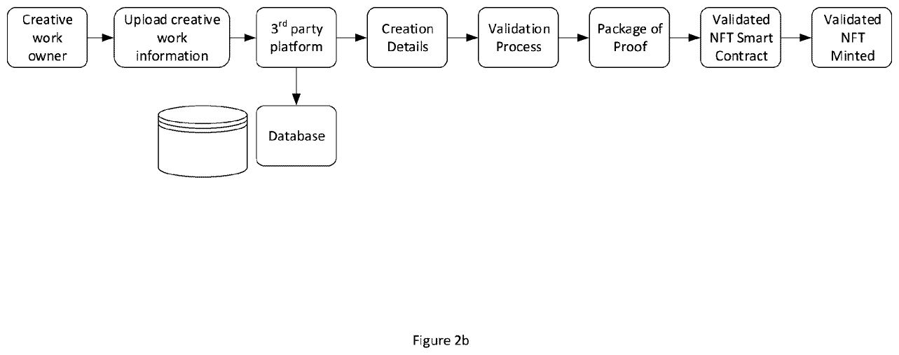

Turning to FIG. 2, a schematic diagram of one embodiment of minting a validated NFT is shown. Details of this process are provided in U.S. Provisional Application No. 63/283,345, filed Nov. 26, 2021 entitled, “SYSTEM AND METHOD FOR ENCAPSULATING TRUST MECHANISMS INTO NON-FUNGIBLE TOKENS”, which is hereby incorporated by reference.

As shown in FIG. 2, once a creative work has been created, the creative work and any supporting documents, such as outlined above, may be uploaded to the system of FIG. 1. In other embodiments, the submission may relate to real property, such as, but not limited to, real estate or concert tickets, and supporting documents may reflect ownership of this real property. In the following description with respect to the figures, the term creative work will also refer to real property as the described methods and systems may protect both creative works and/or real property. Once the input has been received by the system (200) such as in the form of a creative work, real property or property, validation request, the information or data may be stored in a database (202). Concurrently, or after it has been stored, the input may be updated by the system. It is understood that the input (as it is updated through the minting process) may be stored at anytime during the process.

The input (including the creative work and the supporting documents) are then validated by the system (204). In one embodiment, the system may validate the authenticity of the creative work by performing a search to determine if the creative work is original by searching databases. In another embodiment, the system may engage external parties to do the research to determining originality.

Once the system confirms validation of the originality of the creative work (206), the system may then generate a package of proof (208) for the creative work. This package of proof may include a combination of the creative work, the supporting documents, the validation of authenticity and a secret hash (enabling an individual to confirm that the package of proof has been written to or stored on a blockchain). A validated NFT smart contract is then generated (210) once the package of proof has been completed resulting in the minting of a Validated NFT. As discussed above, the generation of the validated NFT may include the generation of a set of child NFTs as well. The validated NFT (and child NFTs) can then be written to the blockchain (212).

As discussed with respect to FIG. 2a, for each generated validated NFT, details about the creative work may be stored as components of the NFT or the NFT may include or store links to where the details are stored externally. These details may include, but are not limited to, supporting documents and/or other information about aspects of the creation of the creative work. For example, this other information may include a copy of the creative work, the name or identification of the creator or author of the creative work and/or the current owner(s) of the intellectual property in the creative work.

In another embodiment, the NFT may include authorship details, a hash of the supporting documents and/or a reference link to externally stored documents/information. All connected smart contracts that are linked to a particular validated NFT may also be stored in the blockchain to provide increased security and to facilitate interconnected activities involving the smart contracts. In order to enable third parties to access the information, the information stored on the blockchain may be read without the need for a trusted third party, thereby providing trustless transparency to the process.

FIG. 2b is a schematic diagram of a combination of system and method for minting a validated NFT.

As outlined above, the generation of the validated NFT may result in some of the shares being created. Using the 100 share example above (as discussed above), the co-owners of the intellectual property (such as those who have purchased some or all of the 75 sold fungible tokens) may have rights and obligations relative to one another that are prescribed by law which may be outlined in a legal agreement or contract.

In some embodiments, these rights and obligations may be varied by way of a co-ownership agreement between the co-owners. For example, the seller (any owner of one or more shares) selling the shares and the buyer or buyers may agree upon purchase terms through a co-ownership contract to set out the rights and obligations. Examples of co-ownership terms are described below. The legal contracts and/or documents, such as the co-ownership contract, can define IP ownership rights, voting mechanisms and instructions for handling payments. In other embodiments of the system, the legal contract/document may include terms and rules beyond ownership, voting and payment.

In some embodiments, the legal document may be incorporated into the NFT via a one-way hash function. The one-way hash function can be used to create a hash of the legal document whereby the hash can be included in the validated NFT record. This may assist to complete the proof of ownership required by the courts and/or the legal system to reflect ownership and ownership rights.

In an embodiment, the provided system and method attempts to minimize or reduce centralization whereby if a centralized third party ceases to exist, the owner of the creative work retains the ability to prove ownership and rights to the creative work.

In some situations, to administer the addition of the legal contract/document's hash into the validated NFT may require some level of centralization or a trusted third party. To overcome this centralization issue, the owner or owners of the creative work can: (i) download or otherwise obtain the hash function used to create the hash of the legal contract/document; and/or (ii) retain the source document (in the form of a digital copy) of the legal file used to generate the hash. Therefore, even if the trusted third party ceases to exist, the owner can prove their ownership stake with the blockchain record (seen as the validated NFT), the legal file, and the one-way hash function used.

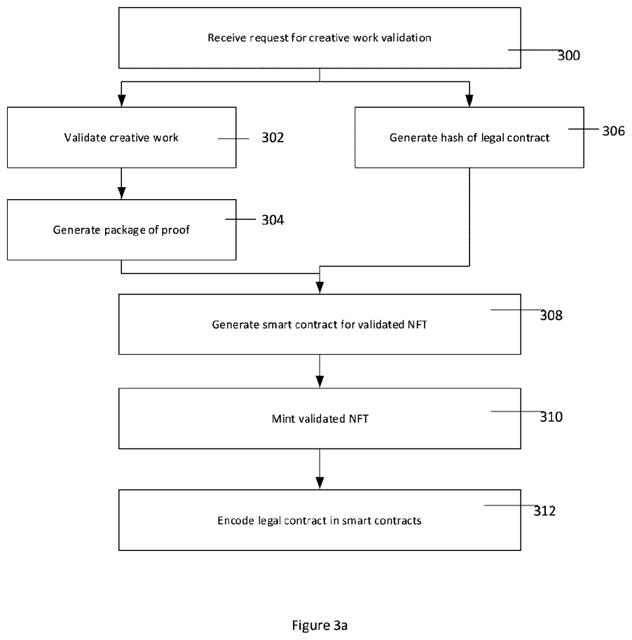

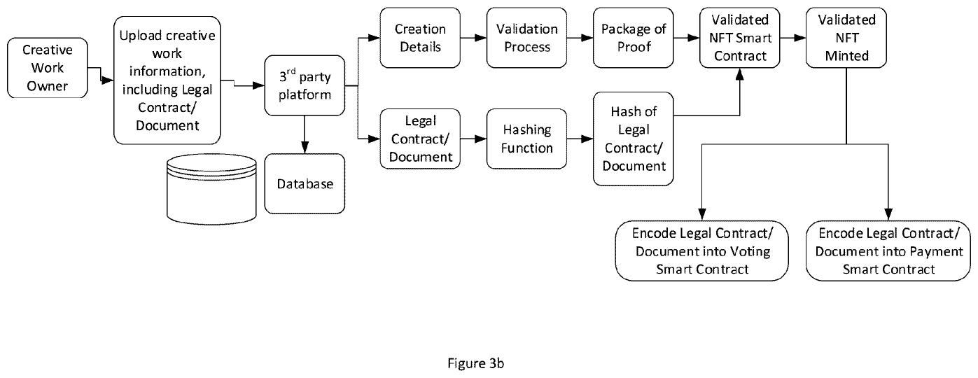

Turning to FIG. 3a, a flowchart showing a method of incorporating a legal contract/document within a Validated NFT is provided. In some embodiments, the method of FIG. 3 may be seen as an extension of the method of FIG. 2a.

Initially, as with the method of FIG. 2, an individual, such as the author or creator of the creative work uploads the creative work along with any supporting documents and the legal contract into the system. The input (which may also be seen as a submission) is received by the system (300). The legal contract may define ownership rights, voting rules, payment rules, etc., as discussed above. The system then validates the submission (302). In one embodiment, the system transmits the relevant creation information to the decentralized validation of intellectual property component to validate an originality or authenticity of the creative work. In one embodiment, this validation process may include receiving input from a decentralized network of certified validators who work to validate the authorship and ownership of the creation, and that it is the creator's unique creation, among other things.

The results of the validation process are then summarized and a package of proof generated (304) which documents all the steps taken during the validation process and proof of the creation's authenticity. This package of proof is then transmitted to the validated NFT Smart Contract component.

Concurrent to the validation process of (302) and (304), the system transmits or sends the legal contract to a hashing function module, or component, to generate a hash of the legal contract (306). In order to generate the hash, the hashing function module may perform a one-way hashing function. A one-way hash function can be used to store a hash of a zipped file of evidence used to prove authorship, ownership, originality or other proof of authenticity of the creative work. Such evidence may include sworn affidavits, work process documents, know-your-client documents, copyright assignments and/or work for hire contracts, originality search reports, and the like. Both the legal contract/document and the zipped file of proof of authorship, ownership and originality can be included in the Validated NFT record. The hash of the legal contract/document is transmitted to the validated NFT smart contract component. Other information that may be transmitted to the validated NFT Smart Contract component may include an identification (ID) number; Owners Information (Owner Address, Number of Shares); Creator Names; Creation Date; File to hash, including the original creation file and/or a zip file of the Package of Proof; and/or Payment Plan (Percentage Type and Value to Parties or Fixed Value or Free).

In one embodiment, the hash function used can be chosen from a menu of options provided by the system or the hash function can be provided by the owner. In another embodiment, the owner may choose to provide the hash directly, which can be incorporated in the validated NFT as legal proof.

The system then generates a validated NFT or a smart contract for the validated NFT (308) based on the information that is received by the NFT smart contract component which includes at least the hash of the legal contract and the package of proof and the Validated NFT is then minted (310). The legal contract/document may then be encoded in smart contracts (312) that define the voting and payment rules, as described in detail below. The validated NFT can then be written to the blockchain.

In one embodiment, with respect to the voting rules of the legal contract, the legal contract/document can specify the owners' rules regarding voting mechanism required to enact changes in the legal contract/documents or in the handling of the ownership of the creative work. As outlined above, these rules can be incorporated into a smart contract, which will allow these rules to always be easily retrieved when the validated NFT is reviewed and/or to enforce the rules in an automated way if triggered. In one embodiment, the smart contract for voting on changes in ownership, granting of licenses to others, or other items that require voting may be referred to as a Voting Smart Contract and may be stored in the Validated NFT record.

The Voting Smart Contract has the ability for any of the owners to create a new resolution to be voted on by the other owners. Each resolution is referenced by the Validated NFT smart contract address and NFT ID, a unique Voting ID, and optionally the smart contract address and NFT ID of any child NFTs (described later). Each resolution contains the tally of how each owner has voted, and the number of shares that owner owns, the outcome of the vote, and a hash of the new agreement/resolution being voted on.

In another embodiment, with respect to payment rules, the owners of legal contract may include instructions, guidance or rules with respect to purchase of the rights to or a portion of the rights to or to license the creative work. In one embodiment, to handle payments, the legal contract/document may also provide guidance or instructions with respect to the rules for payment. For example, for each unit of value to be paid to the owners of a creative work having three owners, 10% may go to owner 1, 70% to owner 2 and 20% to owner 3. In another embodiment of the system, provisions may also be made to compensate the owners of the system responsible for minting the Validated NFT. These payment rules (in the legal contract) can be incorporated into a smart contract which may be seen as a Payment Smart Contract. The address of the Payment Smart Contract can also be included in the Validated NFT record.

In some embodiments, the Payment Smart Contract may facilitate the process for new payment agreements to be created for Child NFTs, with the creation of these agreements controlled by the Voting Smart Contract. Each payment agreement may be encoded into the smart contract and is referenced by the Validated NFT smart contract address and NFT ID, and optionally the smart contract address and NFT ID of any child NFTs (described below). Each payment agreement contains the distribution of payments to the owners, distribution of payments to third parties, and a hash of the payment agreement.

In order to confirm validity of a legal contract, the system may provide mechanism for authenticating the validated NFT. For example, a user may input a hash into the system and if this hash matches the record found on the blockchain, this provides proof that the legal contract/document used to generate the hash is enforceable because only the specific legal contract/document can generate a hash to match the record on the blockchain. For buyers, for example, each NFT buyer receives and retains a copy of the source contract (the same as used to generate the hash). In the future, in cases where the owner/buyer needs to prove that they are the owner of the NFT, they can use that source contract, hash it, and show that the hash generated matches the hash in the NFT record.

FIG. 3b is a schematic diagram showing a combined system and method for minting a validated NFT with a legal contract.

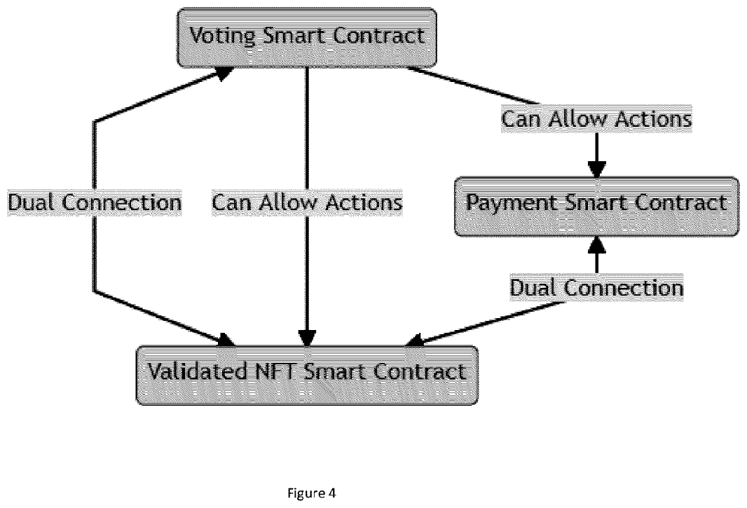

FIG. 4 provides a schematic diagram of how the Voting Smart Contract and Payment Smart Contract are linked to the Validated NFT Smart Contract.

Initially, there is a dual connection between the voting smart contract and the Validated NFT smart contract. This dual connection may be seen as the creation of these two different smart contracts via the same mechanism and information. Actions performed in response to the voting smart contract may be enabled and/or controlled by the contents or the information stored within the Validated NFT smart contract. The payment smart contract may also have a dual connection with the Validated NFT smart contract and may allow actions to be performed on it by the voting smart contract.

In one embodiment of the provided system and method, changes governing rules of ownership, voting requirements, payment handling, or other, can be made via a centralized third party through legal amendments. The legal amendments are added to the original legal contract/document and hashed (via an update) to the Validated NFT. In one embodiment of the system, this would require the Voting Smart Contract.

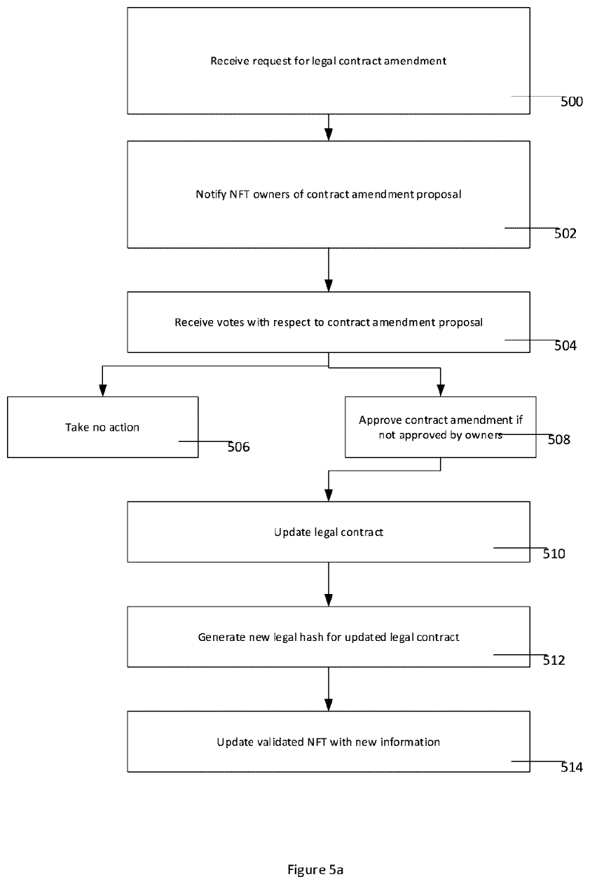

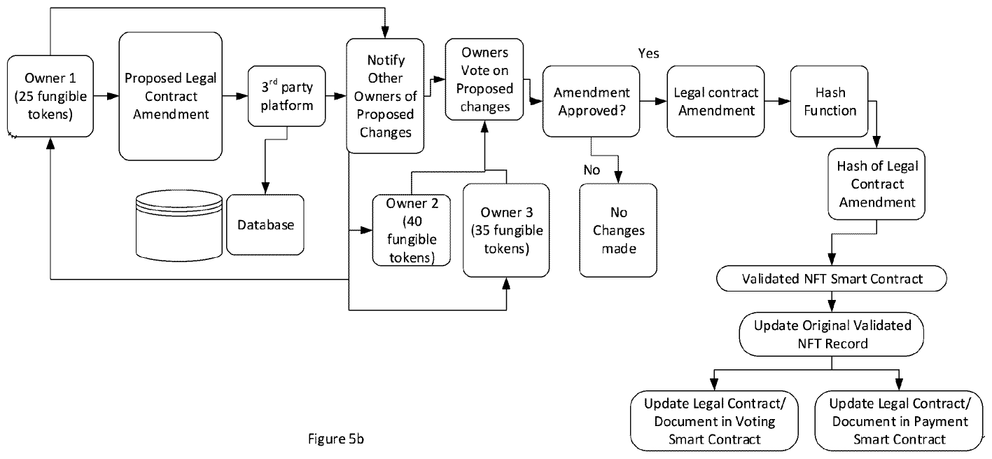

FIGS. 5a and 5b provides embodiments of performing contract amendments. The method of FIGS. 5a and 5b enable users to engage with the system to make amendments to the legal contract/document whether hashed or not. In one embodiment, the system facilitates legal agreements governing voting, payments, rights conveyed, etc., execute electronically, hash and write to blockchain. Once it is on the blockchain, the participants can approve without the 3^{rd} party.

As shown in FIG. 5a, legal contract amendments may be proposed by one of the owners which are then submitted and received by the system (500). The system then notifies all other owners of the NFT (such as owners of child NFTs) that a contract amendment has been proposed (502). With the notification, the owners are also prompted to submit their vote with respect to the contract amendment. The owner votes are then received by the system (504). Depending on the results of the vote, the system may either reject the contract amendment and take no action (506) or approve the contract amendment (508).

If the contract amendment is approved, the system then updates the legal contract document with the approved amendments (510) and then generates an updated legal hash (512) for the updated legal contract. The validated NFT is then updated by the system (514) to include the new legal hash and the original package of proof and other information that was previously stored. In some embodiments, updating the validated NFT may include updating the legal contract document in a voting smart contract or updating the validated NFT may include updating the legal contract document in a payment smart contract. The updated validated NFT can then be re-written to the blockchain.

FIG. 5b is a schematic diagram of a combined system and method of updating a legal contract for a validated NFT.

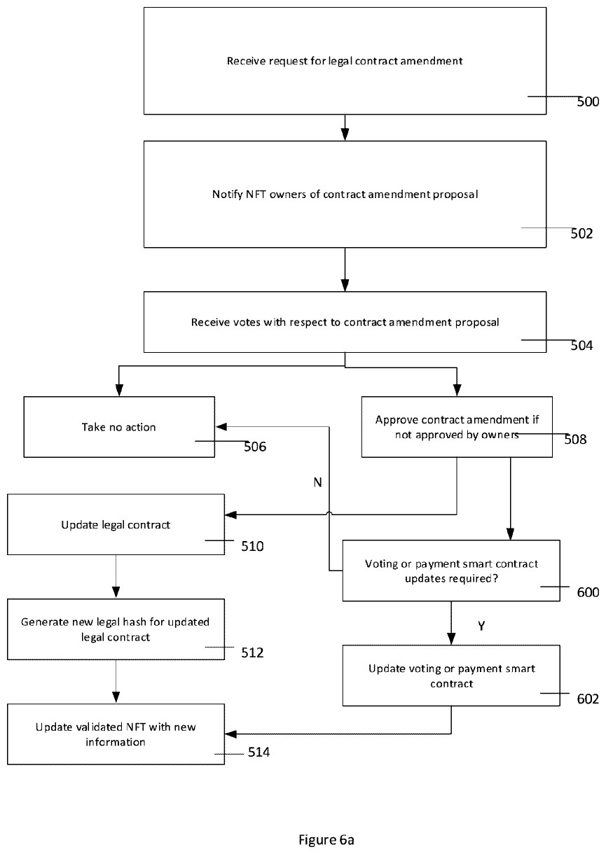

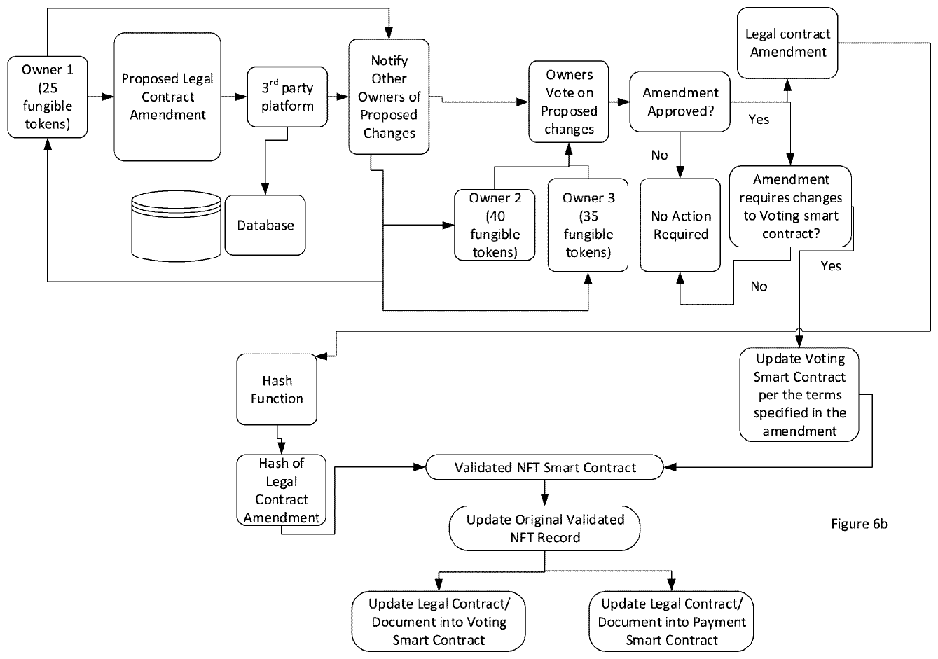

FIG. 6a is an extension of FIG. 5 whereby amendments to the legal contract/document shown in FIGS. 5a and 5b require changes to the Voting Smart Contract or Payment Smart Contract. In an embodiment, the owners select the new parameters governing voting or payment on the 3^{rd} party platform which then serves up the corresponding legal agreement(s) for execution.

As shown in FIG. 6a, once a contract amendment has been approved by owners and then acknowledged by the system (508), a check is performed to determine if these are amendments required to the voting or payment smart contract (600). If there are no amendments, required, the system takes no action (508). If changes to the voting or payment smart contact are required, the voting or payment smart contract is updated as per the contract amendment (602). The updated voting or payment smart contract is then included in the validated NFT contract and the validated NFT contract updated (514).

FIG. 6b is a schematic diagram of a combined system and method for making amendments to a legal contract and updating a voting or payment smart contract.

As described above, there may be a need to mint child NFTs that are based on or associated with the validated NFT. Once a validated NFT is minted, one or more child NFTs can be minted. In one embodiment, the child NFTs may be used to provide rights to owners of the validated NFTs or third parties. The rights may include, but are not limited to, collectible versions of the creative work; certificate of authenticity for the creative work; contractual right to print; contractual right to publish; contractual right to perform; contractual right to film; contractual right to record and/or multiple contractual rights.

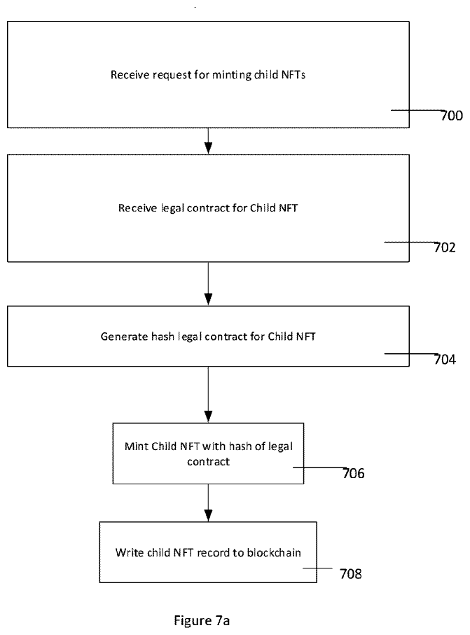

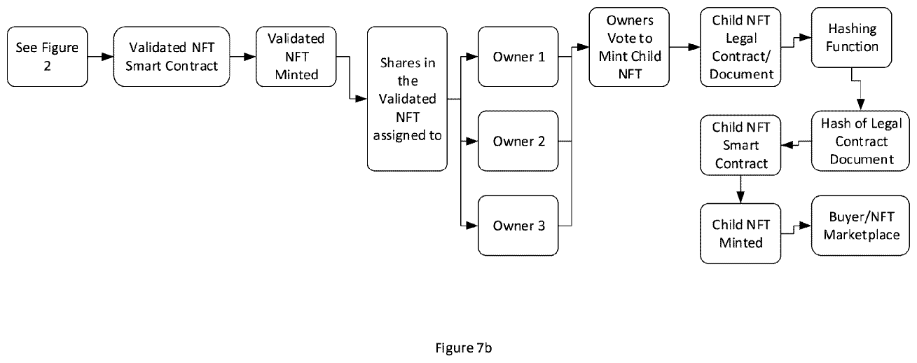

Turning to FIG. 7a, a flowchart showing a method of minting a child NFT is shown. After the validated NFT is created or generated, the owners of the validated NFT can use the voting smart contract to approve minting of child NFTs. This request for the minting of child NFTs or approval for the minting of child NFTs is received by the system (700). Depending on the NFT, the voting requirements or the approval requirements may be different for each NFT. These voting details may be stored within the system or associated with the NFT.

The system may then receive a legal contract for the child NFT (702). In some embodiments, this legal document can be generated by the system and in other embodiments, the contract is uploaded to the system by a user. The child NFT legal document is then hashed (704) such as via a hashing function. The hash of the legal contract/document is then transmitted to a smart contract component so that it is included in the minting of the child NFT's (706) and the child NFT's record is then stored on or written to the blockchain (708). After the child NFT is minted, it can be sold directly to buyers or listed on an NFT marketplace.

FIG. 7b is a schematic diagram of a combined system and method for minting a child NFT.

Similar to the method described above for validated NFTs, the child NFT may include readable fields after being stored on the blockchain. These readable fields may provide content directly on the blockchain to provide transparency to the process. In one embodiment of the disclosure, the readable field may include terms like PRINT or PERFORM, which identify that the holder of the child NFT has rights to print the creative work or perform the creative work. In another embodiment of the disclosure, each child NFT may include functions that a user can use to confirm if the owner has any specific rights to the NFT. For example, the functions may return a value of TRUE only if the owner has the right to print/perform the creative work that is defined in the validated NFT. In other embodiments, the system may allow Web3 or other wallet applications, websites offering blockchain services such as smart contract websites or user developed code to interact with the smart contract (web3, ethers, etc) to programmatically execute the functions (directly or indirectly) such as via JavaScript to obtain reply information, similar to other token functions for account balance and the like.

In another embodiment, the validated NFT owners may give rights to the child NFT owners that may generate revenue from the underlying IP rights creative work (e.g. right to print or perform). Details of these terms and rules for payment may be encoded into the payment smart contract and referenced using the child NFT such as via its contract address and NFT ID. This is similar to the process described above for Validated NFTs. The Payment Smart Contract can allow payment to be made to both child NFT owners and validated NFT owners. The Payment Smart Contract distributes payment following the rules in the legal contract/document executed between the Validated NFT owners and Child NFT owner.

In a further embodiment of the disclosure, the legal contract/document may also specify whether the rights conveyed to the owner of the child NFT are transferrable upon a sale of the child NFT or whether the owners of the validated NFT need to approve the sale using their voting smart contract. A readable field, and function, can be included in the Child NFT's record on the blockchain to show whether the child NFT is freely transferrable (e.g. TRANSFERABLE and areRightsTransferableo).

In some embodiments of the disclosure, a creator of a creative work can mint a validated NFT for IP rights associated with the creative work. With the Validated NFT, the creator can then use a 3^{rd} party platform to mint a child NFT that allows an instance of the creative work to be downloaded. Multiple child NFTs can be minted for multiple copies of the work. A child NFT can then be sold to a party interested in downloading the creative work. In this example, a standard legal contract/document can be used with the purchaser's information populated into the template before being hashed and stored in the child NFT's record.

In another embodiment of the provided systems and methods, this model can be used to facilitate business-to-business transactions between legal entities. For example, a motion picture, gaming or other studio can license a story character to a toy manufacturer. The Child and Validated NFT's Voting and Payment Smart Contracts can be used to ensure that payments flow to the appropriate parties based on the terms in the legal contract/document hashed and included in the record on the blockchain. Utilizing this form of business-to-business transactions allows for clear records of payments and can help facilitate court proceedings in cases where over or under payment has occurred. In an embodiment, fulfilment data is received to trigger the smart contract to make payments. If a Child NFT is minted and the contract between the Validated NFT owners and the Child NFT owner states that each resale of the Child NFT will return 10% to the Validated NFT owner, that will automatically funnel payment back to the Validated NFT owner.

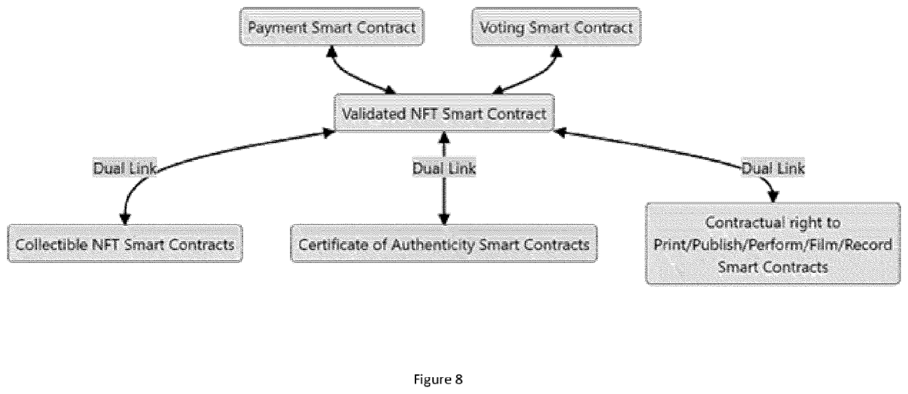

FIG. 8 provides a schematic of how the validated NFT would be tied to the various examples of child NFTs described above.

In one embodiment of the provided system and method, the Child NFTs are linked to the Validated NFT using a dual link, where each Child NFT stores the connected Validated NFT contract address and NFT ID; and that corresponding Validated NFT stores the Child NFT's smart contract address the NFT ID.

Whereas Validated NFTs use a fungible batch of tokens to define a non-fungible token representing IP rights in a creative work (e.g. ERC-1155, as described above), Child NFTs can be minted using token standards that have only one owner address for each NFT. In one embodiment of the disclosure, the Child NFTs can be ERC-721 standard on the Ethereum blockchain. However, Child NFTs can also be minted on other Layer 1 blockchains or Layer 2 solutions. In an embodiment, child NFTs can reference a Validated NFT on the same chain or on another chain. Child NFTs can either be minted and immediately be owned by the contracting party in the corresponding transaction or can be minted to the owner of the Validated NFT or 3rd party platform (in custody) and transferred to the ultimate owner/buyer.

Similar to the method described above for validated NFTs, the legal rights of a child NFT can be specified in a legal contract/document. The legal contract/document can be prepared and executed using a trusted third-party platform. This legal contract/document will specify the rights provided to the owner of the NFT by the owners of the validated NFT. The legal contract/document can include, but not limited to, rights such as duration of the agreement, payment handling, and transferability.

Similar to the method described above for validated NFTs, once the legal contract/document is executed it can be hashed using a one-way hash function. This can then be stored in the child NFT's record on the blockchain.

Similar to the method described above for validated NFTs, if the legal contract/document has clauses associated with voting or payment, these are encoded into the voting and payment smart contracts. In an embodiment, the system may review standard agreements (e.g template terms and conditions, etc.) for multiple use. Terms of service etc. can include indemnity clauses for use of the system.

In another embodiment of the disclosure, the owners of the validated NFTs can use the system to input terms and rules defining ownership, payment, and voting associated with the NFTs. For example, an owner of a validated NFT may input the voting mechanism rules (e.g. >50% vote required) in an online interface provided by the system. The interface would allow the owners of the NFTs to submit votes, proposed changes to voting, ownership and payment rules and terms.

The disclosure may also be implemented by deploying a single smart contract or by deploying multiple smart contracts. By deploying multiple smart contracts, the system can allow trusted third parties to work with validated NFTs. This also provides optionality to add more features to validated NFTs that are specifically desired by each trusted third party.

In one embodiment of the system, each voting smart contract and payment smart contract would be unique to the NFT. In another embodiment of the system, voting smart contracts could be used for multiple NFTs whereby the rules binding them are identical. For example, in multiple cases where a Child NFT is provided rights to license the creative work and collect 25% of revenues generated, the same smart contract could be used for multiple NFTs. It will be understood that primary terms of the smart contract are reusable (e.g. in respective instances of the contract on the blockchain) and that the respective parties (and their block chain addresses, etc.) are different according to the respective instances. So, if a payment smart contract is re-used in a respective instance on the blockchain, such as because the splits are the same, the addresses that are paid are different and based on the owner of the child NFT and owner(s) of the Master NFT.

In the preceding descriptions for Validated NFTs and Child NFTs, while a legal contract/document that includes ownership, voting and payment terms and rules is disclosed, it is understood that the method and system may be applied to other forms.

Generally, the system and method provided in this disclosure allows for public, transparent, immutable and secure proof of ownership of the creative work; assigned ownership, licensing, and other rights; payment tracking and voting. All of which is provided in a manner that respects legal agreements required by courts (facilitated by a trusted third party) but not requiring that trusted third party to prove an owner's rights.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be affected to the particular embodiments by those of skill in the art without departing from the scope, which is defined solely by the claim appended hereto.

What is claimed is:

1. A method of enforceable and divisible tokenization of property comprising:
generating a validated non-fungible token (NFT) based on a validated item submission;
generating at least one child NFT based on the validated NFT; and
storing the validated NFT and the child NFT on the blockchain.

2. The method of claim 1 wherein generating a validated NFT comprises:
receiving a package of proof representing the validated item submission;
receiving a legal contract associated with the validated item submission; and
minting at least one validated NFT based on the package of proof and the legal contract.

3. The method of claim 2 further comprising, before minting the validated NFT,
generating a hash of the legal contract; and
minting the validated NFT based n the package of proof and the legal contract includes storing the hash in the minted validated NFT.

4. The method of claim 2 further comprising:
receiving a request for a legal contract update;
receiving approval of legal contract update;
receiving legal contract update;
generating a legal contract update hash; and
re-minting the validated NFT with the legal contract update hash.

5. The method of claim 1 wherein generating at least one child NFT comprises:
minting at least one child NFT based on the validated NFT and associating the at least one NFT with the validated NFT.

6. The method of claim 5 further comprising:
assigning ownership rights for each of the at least one child NFTs.

7. The method of claim 5 wherein minting at least one child NFT comprises:
minting the at least one child NFT with a legal contract hash.

8. The method of claim 5 wherein minting at least one child NFT comprises:
minting at least one of the at least one child NFTs with a payment smart contract outlining a payment relationship between owners of the at least one child NFT and the validated NFT.

9. The method of claim 8 wherein the payment smart contract is associated with a legal contract.

10. The method of claim 1 wherein generating a validated non-fungible token (NFT) based on a validated item submission comprises:
generating a batch of fungible tokens as a proxy for ownership shares or rights.

11. The method of claim 2 wherein generating a validated NFT further comprises:
minting the validated NFT with a voting smart contract outlining voting rules with respect to ownership of the validated NFT and the at least one child NFT.

12. The method of claim 11 wherein the voting smart contract is associated with the legal contract.

13. The method of claim 2 wherein generating a validated NFT further comprises:
minting the validated NFT with a payment smart contract outlining a payment relationship between owners of the validated NFT.

14. The method of claim 13 wherein the payment smart contract is associated with the legal contract.
